(19) United States
(12) Patent Application Publication
(10) Pub. No.: US 2016/0354884 A1
(43) Pub. Date: Dec. 8, 2016

(54) MACHINE TOOL

(71) Applicant: H.C. Burkhart Grob, Bad Worishofen (DE)

(72) Inventor: H.C. Burkhart Grob, Bad Worishofen (DE)

(73) Assignee: GROB-WERKE GmbH & CO. KG, Mindelheim (DE)

(21) Appl. No.: 15/172,111

(22) Filed: Jun. 2, 2016

(30) Foreign Application Priority Data
Jun. 2, 2015 (DE) 10 2015 108 730.8

(51) Int. Cl. B23Q 1/52; B23C 1/04; B23Q 5/04

(52) U.S. Cl. CPC B23Q 1/52; B23Q 5/04; B23C 1/04

(57) ABSTRACT

The invention refers to a machine tool with a work piece table, wherein a clamping or lifting means disposed on the work piece table is driven by temporary power transmission from outside the work piece table. The invention also refers to a corresponding method.

### FIELD OF THE INVENTION

The invention refers to a machine tool, in particular a metal cutting machine tool with at least one motor spindle rotatably driving a respective tool, and a work piece table, at or on which the at least one work piece is clamped directly or indirectly through a pallet carrying the work piece during the machining process, by means of a clamping device. For transporting the work piece or the pallet carrying the work piece from a preparation area to the work piece table and back, at least on the work piece table surface a rolling track is provided, on which the work piece or pallet rests for transport. The pallet can be provided on its underside with rollers, wherein the rollers are positioned in a respective track portion in the clamped position of the work piece or pallet on the work piece table. In the work piece table a lifting device may be provided.

### BACKGROUND OF THE INVENTION

Modern machine tools allow a multisided machining of the work piece. This can be achieved, among other things, because the work piece table is rotatable at least about a vertical axis. It is known to provide in the work piece table the clamping device for clamping the pallet or work piece as well as a lifting device for rollers or rolling track. Both the clamping device and the lifting device need power, through a hydraulic or pneumatic or electric connection, in order to activate themselves.

In the state of the art it is known to feed this power to the work piece table through a power line. The power supply is provided through fixed connections. This power line must be provided so that a rotational movement about above said rotation axis should be fundamentally possible. These boundary conditions require correspondingly costly and maintenance intensive rotary connections for power transmission.

### SUMMARY OF THE INVENTION

The object of the inventions is to improve the state of the art.

This is achieved by machine tools according to the main claims as well as a method according to the independent method claim. Advantageous embodiments may be obtained, for example, from the respective dependent claims.

The invention refers to a machine tool, in particular a metal cutting machine tool, with at least one motor spindle rotatably driving a respective tool, and a work piece table, at or on which the at least one work piece is clamped directly or indirectly through a pallet carrying the work piece during the machining process, by means of a clamping device. The clamping device comprises at least a clamping means, a clamping drive and a clamping power connection, wherein the clamping means cooperates with the work piece or the pallet carrying the work piece, the clamping drive, by use of the power supplied by the clamping power connection, drives the clamping means for clamping and/or releasing the work piece and the clamping power connection may be temporarily connected with a power transmission connection piece, wherein the power transmission connection piece is operatively connected with a power source and the power transmission connection piece is movable to and back from the clamping power connection by means of a movement drive.

The invention also refers to a machine tool, in particular a metal cutting machine tool, with at least one motor spindle rotatably driving a respective tool and a work piece table, at or on which the at least one work piece is clamped in an exact position directly or indirectly through a pallet carrying the work piece during the machining process by means of a clamping device. In particular, the machine tool may be as defined above. For transporting the work piece or the pallet carrying the work piece from a preparation area to the work piece table and back, on the work piece table surface a rolling track is provided, on which the work piece or the pallet is resting for transport, or the pallet is provided on its underside with rollers and the rollers are positioned, in the clamping position of the work piece or the pallet on the work piece table, in a respective track portion. In the work piece table a lifting device is provided, wherein the lifting device comprises at least one lifting means, a lifting drive and a lifting power connection, wherein the lifting means cooperates with the rolling track or the track portions, the lifting drive, using power provided by the lifting power connection, drives the lifting means for lowering and/or lifting the rolling track or the track portions and the lifting power connection is temporarily connectable to an power transmission connection piece, wherein the power transmission connection piece is operatively connected to a power source and the power transmission connection piece is movable in a forward or backward direction with respect to the lifting power connection by means of a moving drive.

The gist of the invention lies in the fact that it has been recognized that for the operation of the clamping and lifting device a constant power supply is not required. In particular, the invention proposes to supply the power required for the operation of the clamping device or lifting device only temporarily in a limited way through a separately applicable power transmission connection piece on one side to the clamping power connection or on the other side to the lifting power connection. The inventive proposal therefore avoids the rotary connections or links. The inventive proposal is applicable with reference to all functions provided on the work piece table, which require power, i.e. only a power connection on the respective device is required, which interacts with the power transmission connection piece.

The work piece or the pallet carrying the work piece usually rests on the work piece table. The invention however is not limited to this geometric arrangement. A work piece table in the sense of the present invention is also an arrangement, in which the work piece or the pallet is suspended in the processing situation.

The inventive proposal may also be applied to constructive forms, in which a pallet carries more than one work piece, for instance, two, three, four or more.

As equivalent is also considered in this case the principle of cinematic inversion in configuration of the power connection. It is for instance possible to provide an (mechanical or electrical) energy accumulator in the work piece table, which, if necessary, acts on a drive of the movably supported clamping or lifting connection, such as to perform a movement towards the preparation area.

The front area, from which the pallet carrying the work piece is transported to the work piece table and back, may, for instance, be considered a place, where the pallet with the work piece to be machined is equipped, i.e. prepared. The front area may also be an exchange position in a concatenated line of machine tools.

In an enhanced version of the invention, it is alternatively envisaged to combine the concepts proposed in the present application.

According to an embodiment, it is envisaged that the work piece table is movable and may be positioned along a linear guide by means of a linear drive. This allows an automated displacement and positioning of the work piece table, in particular in horizontal direction.

The proposal also advantageously envisages that the work piece table is movable and may be positioned about a vertical axis or a rotation axis which is perpendicular to the linear axis by a rotary drive. This allows a machining on all sides of a work piece positioned or clamped on the work piece table.

In a preferred form of the proposal it is envisaged that, in case of relative approaching movement of the power transmission connection piece on one side and of the clamping power—or lifting power connection on the other side, these are inserted together, in particular with a form fit. This allows a direct transmission of a movement, in particular a rotatory movement. For example, a movement of a spindle or other tool, in particular a rotatably driven tool, a screwdriver, for example, may be transmitted. The tool may in particular be already present, i.e. it may be provided independently from the function of driving by the clamping power—or lifting power connection.

It is also envisaged, that on the work piece table a central power connection is provided, which is temporarily used as a clamping power connection and as a lifting power connection and a switching device for selectively connecting the clamping drive or the lifting drive to the power connection. Therefore, two separate power connections may be omitted. This allows for a compact construction. The switching device may for instance be operated through a mechanical external switch or an electric operating device, such as a radio remote control.

In an advantageous embodiment it is envisaged that the power source is the rotational energy of a screwdriver or motor spindle, electrical energy, pneumatic or hydraulic energy and that the power transmission connection piece is a torque transmitting element, such as a polygon, electrical connector or pneumatic or hydraulic coupling element. In this way corresponding available energy forms may be perused. The rotational energy of a screwdriver or of the motor spindle may be used, for example. Electrical energy may also be used, providing corresponding electrical connectors or contacts on the transmission connection piece and on the clamping and/or lifting power connection. Moreover, hydraulic or pneumatic available energy may be used.

The work piece change typically takes place during time periods where no machining off the work piece takes place and therefore the motor spindle is inactive. During this change pauses, according to the inventive proposal, motor spindle is additionally used.

It is advantageously envisaged that the clamping power connection or the lifting power connection are shaft stubs to be driven by the connectable rotation power source, electrical connector counter contact or as a hydraulic or pneumatic coupling counter element. This too allows an advantageous use of the already described power sources, for example.

In a further preferred embodiment, it is envisaged that the power transmission connection piece is fixed to the machining tool and that the work piece table and the connected clamping or lifting power connection are movable, connectable and then again releasable, according to a linear movement or in a rotational way around a rotational axis, to and from the power transmission connection piece. This allows the inventive advantages even in the case that for instance a tool spindle is stationary.

Moreover it is advantageously envisaged that the motor spindle maybe movably positioned along two linear axes by means of their respective motor spindle linear drive wherein both linear axis of the motor spindles are perpendicular to the longitudinal extension of the linear guide of the work piece table. This allows a two-dimensional and therefore more flexible positioning wherein the linear guide of the work piece table may have a further axis.

Advantageously, in the proposal, it is such that the movement drive is formed by at least one motor spindle linear drive. The movement drive may therefore linearly displace the motor spindle.

According to an embodiment the clamping or lifting drive is provided by a transmission, a hydraulic pump, an electrical motor, pressure supply or pressure accumulator. In this way above said energy sources may be advantageously used.

In a preferred embodiment of the proposal the clamping means is a spring loaded clamping gripper arrangement and the clamping drive provides a force opposed to the spring for opening the clamping means. In this way the work piece maybe held by a force defined by the spring, wherein the force provided by the spring is overcome by the clamping drive only in case of opening for instance in order to change the work piece.

Moreover the lifting means is provided with a linear guide which lifts or lowers the rolling track or the track portion. This in particular allows the fixing of the pallets or the work pieces by lifting, which clearly facilitates the machining by means of tool.

In an advantageous embodiment, on the work piece table in particular in the area of the clamping or lifting power connection a control line connection is provided which interacts with the clamping drive, lifting drive or the switching device and which is connectable to a control line connection piece and wherein the clamping drive connection piece and the control line connection piece maybe moved towards the control line connection and back by means of a movement drive. This allows the transmission of information between the machine control and the work piece table, components of the work piece table and/or the work piece to be processed or its respective components. It also allows in particular the transmission of control commands from the machine control to the work piece table, whereby for instance the switching device maybe operated. In this way it is possible to select if energy has to be supplied to the clamping or lifting power connection.

The proposal also advantageously comprises the fact that respective two of the preferred four clamping or lifting means are connected through partial power line. This allows a common actuation of respective two lifting or clamping means, in order to operate them in synchronism. Therefore it is possible to avoid that because of a different or imprecise activation of the lifting or clamping means the work piece may be lifted obliquely or fixed in a position which is not the desired one. This avoidance of machining errors and minimizes tolerances.

In a further preferred embodiment it is provided that the clamping means exerts a clamping force which is parallel, In particular radial with respect to the rotation axis or perpendicular to the work piece surface of the work piece table. This allows a simple and defined force and movement profile.

The invention also refers to a machine tool with at least a motor spindle and the work piece table, on which the at least one work piece is clamped during the machining by means of the clamping device. The clamping device comprises at least one clamping means, one clamping drive and one shaft stub, wherein the clamping means cooperates with the work piece or with the pallet which is carrying the work piece. The clamping drive drives using the power provided from the shaft stub, the clamping means for clamping and/or releasing the work piece and the shaft stub is temporarily connectable with the screwdriver or the motor spindle maybe moved towards the shaft stub or back by means of a movement drive.

By means of such an embodiment of the machine, similar or identical advantages maybe obtained as in the already described embodiment. It is also to be noted that all variants and embodiments described in this application may also be applied correspondingly to the already described embodiments.

The invention also refers to a machine tool with at least a motor spindle and a work piece table, on which the at least one work piece is clamped during machining. In the work piece table a lifting device is provided, wherein the lifting device comprises at least one lifting means, one lifting drive and one shaft stub. The lifting means cooperates with the rolling track. The lifting drive drives, using the energy provided by the shaft stub, the lifting means in order to lower and/or lift the rolling track and the shaft stub is temporarily connectable with a screwdriver or with the motor spindle, wherein the screwdriver or the motor spindle are movable towards the shaft stub or back by means of a movement drive.

Also with such an embodiment similar or identical advantages may be obtained with reference to above embodiments with lifting devices. It is noted that all variants and embodiments described in this application may also be transferred to the previous embodiment.

The invention also refers to a method for loading a work piece from a front area or preparation area on or at the work piece table of a machine tool. In particular, the work piece table may be one of the embodiments described in this application. The work piece table is provided with a lifting device and a clamping device, wherein the work piece is transported on the work piece table on a pallet carrying the work piece with rollers. The rollers are positioned, at the end of the movement, on track portions, wherein at the same time or afterwards, a power transmission connection piece is moved with respect to the work piece table in a way that a connection between the power transmission connection piece and a lifting power connection is established, energy then goes to a lifting means of the lifting device and the rolling track or the track portions are lowered in a way that the rolling track or rollers are no more active and the work piece or the pallet carrying the work piece rests on the work piece table. At the same time, or afterwards, the power transmission connection piece is moved with respect to the work piece table or the switching device is operated in a way that a connection between the power transmission connection piece and a clamping power connection is established, so that energy may then be provided to a clamping means of the clamping device and clamping elements positioned on the work piece table or on the pallet carrying the work piece table cooperating with the clamping means engage the work piece and clamp it in an exact position on the work piece table and then the power transmission connection piece is separated from the clamping power connection, whereby the active connection between power transmission connection piece and clamping power connection is interrupted.

By means of the inventive method, the above said advantages of inventive devices may be obtained. It is to be noted that embodiments and variants described with reference to inventive devices may also be generally applied to the inventive method, and vice versa.

In an embodiment of the method, it is envisaged that after the work piece or the pallet carrying the work piece is resting on the work piece table, the work piece table is rotated and/or linearly moved. This allows for an automatic and precise movement and/or positioning of the work piece.

Moreover it is advantageously envisaged that initially the power transmission connection piece is connected with the lifting power connection, this connection is interrupted, the work piece table is rotated and/or linearly moved and then the power transmission connection piece is connected with the clamping power connection. This allows in particular a clamping of the work piece, after it having been positioned by the work piece table.

Since both movements of rollers or lifting on one side and clamping on the other side do not otherwise temporarily overlap, it is advantageous to get one and the same power connection piece, in succession, at the different power connections of devices provided, in this case the lifting device and the clamping device. For this, the movement of the work piece table on one side and of the power connection piece on the other side may be advantageously used.

In this context it is to be noted that all characteristics and features described with reference to the machine tool but also procedures are conveniently transferrable to the formulation of the inventive method, and they may be used according to the invention, and are considered to be also disclosed. The same holds in the opposite direction, i.e., construction or device related features which are cited only with reference to the method, may also be considered in the context of the claims for the machine tool, and may also be claimed and are part of the disclosure.

The invention also comprises the use of an inventive machine tool according to one or more of preceding embodiments for clamping and/or machining the work piece.

### BRIEF DESCRIPTION OF THE DRAWINGS

The invention description below refers to the accompanying drawings, of which:

FIG. 1 is a lateral view of a machine tool according to the invention and a first exemplary embodiment;

FIG. 2 is a plan view on the machine tool according to the first example;

FIG. 3a is a lateral section view of a work piece table of a machine tool according to the invention in a second example;

FIG. 3b shows a lateral section view of a work piece table of a machine tool according to the invention in a third example;

FIG. 4 is a further lateral section view of the work piece table of the machine tool of the third example;

FIG. 5 is a lateral section view of a work piece table of a machine tool according to the invention in a fourth example;

FIG. 6a is a plan view of a work piece table of a machine tool according to the invention in a fifth example; and

FIG. 6b is a plan view of a work piece table of a machine tool according to the invention in a sixth example.

### DETAILED DESCRIPTION

In the figures, same or corresponding elements are provided with the same references and their description is not repeated, unless necessary. Disclosures in the whole description are transferrable to same parts with same references or same component names. The indications of position chosen in the description, as for instance, up, down, side, etc., also refer to the instant represented figure and have to be transferred, analogously, to the new position, in case of a change of position. Moreover, also individual features or feature combinations from the different exemplary embodiments shown and described may represent independent inventive solutions or solutions according to the invention.

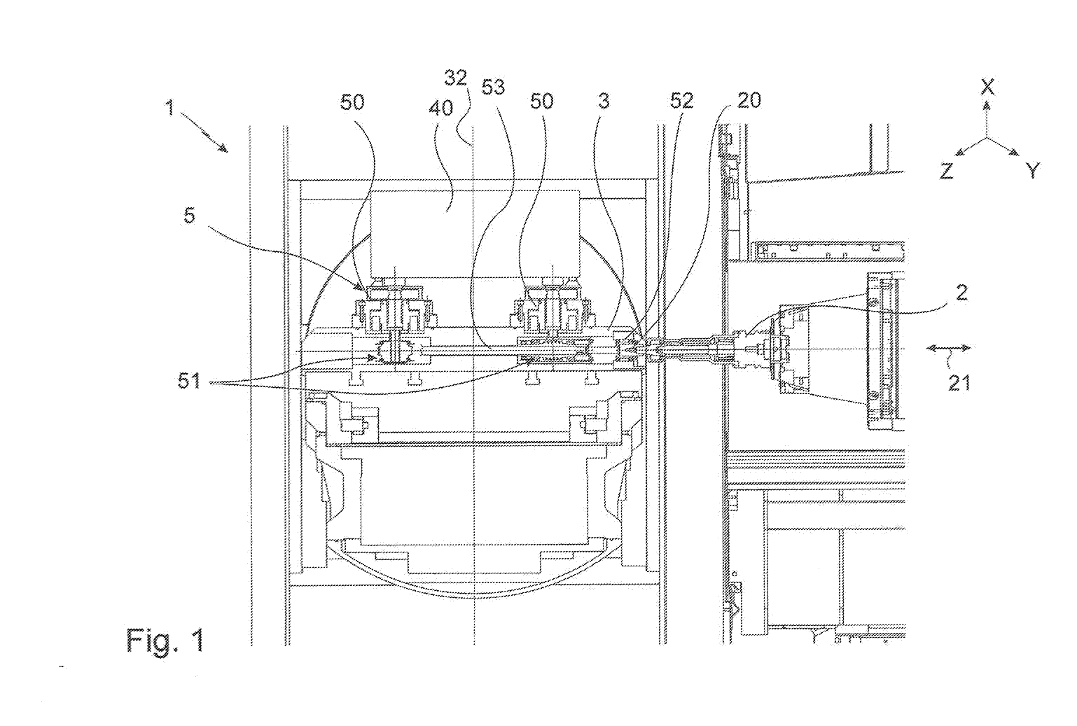

FIG. 1 shows a side view of a machine tool 1 according to a first exemplary embodiment. The machine tool 1 is provided for machining a work piece not shown, which is supported by a pallet 40. Pallet 40 is held on a work piece table 3 in way that is described in the following. The work piece table 3 is rotatable around a vertical axis 32, so that the pallet 40 may be correspondingly rotated.

For the machining of the work piece a motor spindle 2 is provided, which is configured for holding a tool and rotatably driving the same. The tool can be, for example, a drill bit or a grinding head. The motor spindle 2 may however also hold a tool, which is specifically configured for actuating, as described later, devices on the work piece table 3. A hexagon may for example be held.

In the work piece table 3, a clamping device 5 is provided. The clamping device 5 has two clamping means 50. The clamping means 50 are configured for holding the pallet 40 on the work piece table 3. To each of the clamping means 50 a clamping drive 51 is associated, which is used for actuating the clamping means 50, in particular for clamping and releasing the pallet 40.

For common drive of clamping drive 51, the clamping device 5 is provided also with a clamping power connection 52. This is arranged on the outside of the work piece table 3 and is used for holding a tool for actuating the clamping power connection 52. Such tool may for example be a hexagon, which is held in the motor spindle 2 and is driven by the latter, as already noted. This allows the driving of the clamping device 5 by the motor spindle 2, whereby a rotating rod 53 is provided for connecting the clamping power connection 52 to the clamping means 50. The hexagon can be called a power transmission connection piece 20 in this use.

The embodiment shown and described allows the use of the already present motor spindle 2 for machining the work pieces, also for clamping and releasing the pallet 40. Additional driving members can therefore be omitted. In particular, costly, error and maintenance intensive mechanisms for transmission of electrical or mechanical energy to the rotatable work piece table 3 may be omitted.

The motor spindle 2 is movable along its rotational axis, which is indicated by the double arrow 21. This allows the power transmission connection piece 20 to be moved to the work piece table 3 and back again. In this way the work piece table 3 may be rotated with an orientation, which allows an engagement of the power transmission connection piece 20 held in the motor spindle 2, in order to allow a clamping or releasing of pallet 40 during use of the motor spindle 2. Thereafter, the power transmission connection piece 20 may again be removed, allowing the work piece table 3 to be rotated or positioned in another position suitable for machining the work piece.

The motor spindle 2 is movable in three dimensions, as shown in FIG. 1 by an axis-cross. This allows the free displacement of the motor spindle 2 for machining the work piece.

The machine tool 1 also contains means, not shown, for automatic change of tool held in the motor spindle 2. This allows not only the use of different types of tools without manual intervention, but also the positioning and removal of the power transmission connection piece 20 to and from the motor spindle 2.

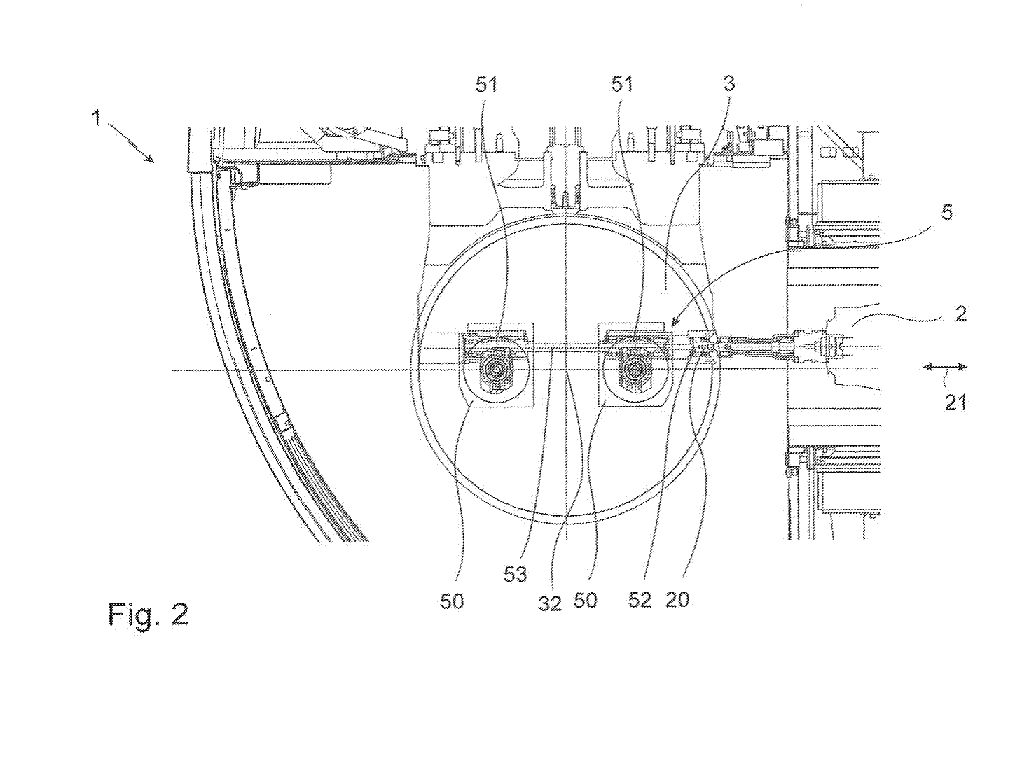

FIG. 2 is a plan view of the machine tool 1 according to the first exemplary embodiment. It may be noted that both clamping means 50 are arranged approximately at the same distance from the horizontal center point of the work piece table 3. This allows the clamping of the pallet 40 or the work piece over the horizontal center point, through which also the rotational axis 32 of work piece table 3 extends. This contributes to minimize or eliminate imbalances.

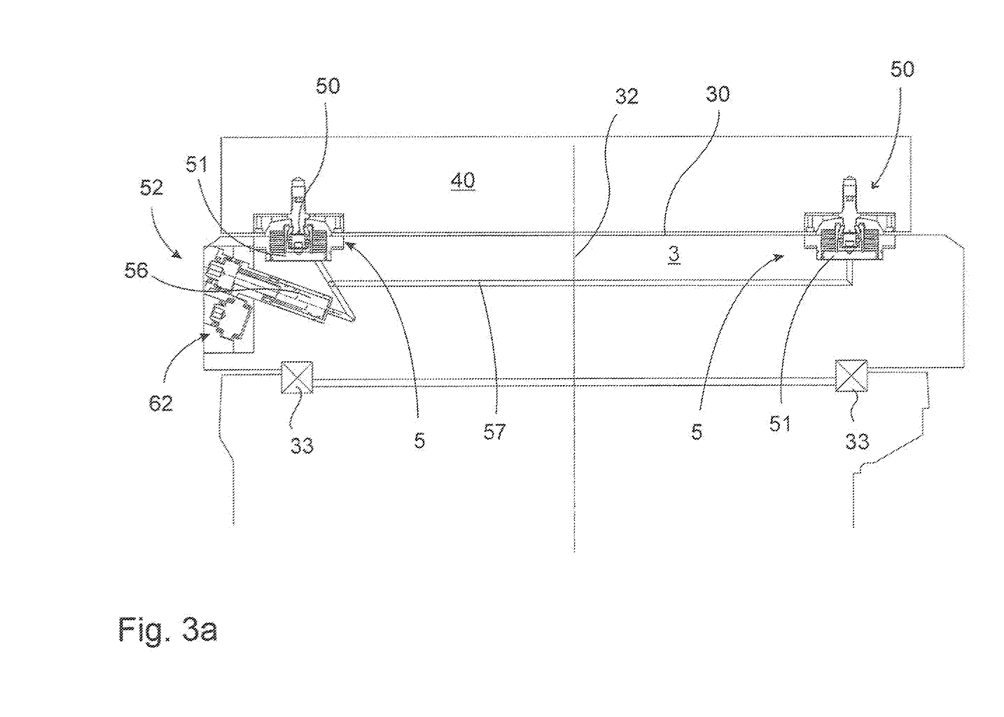

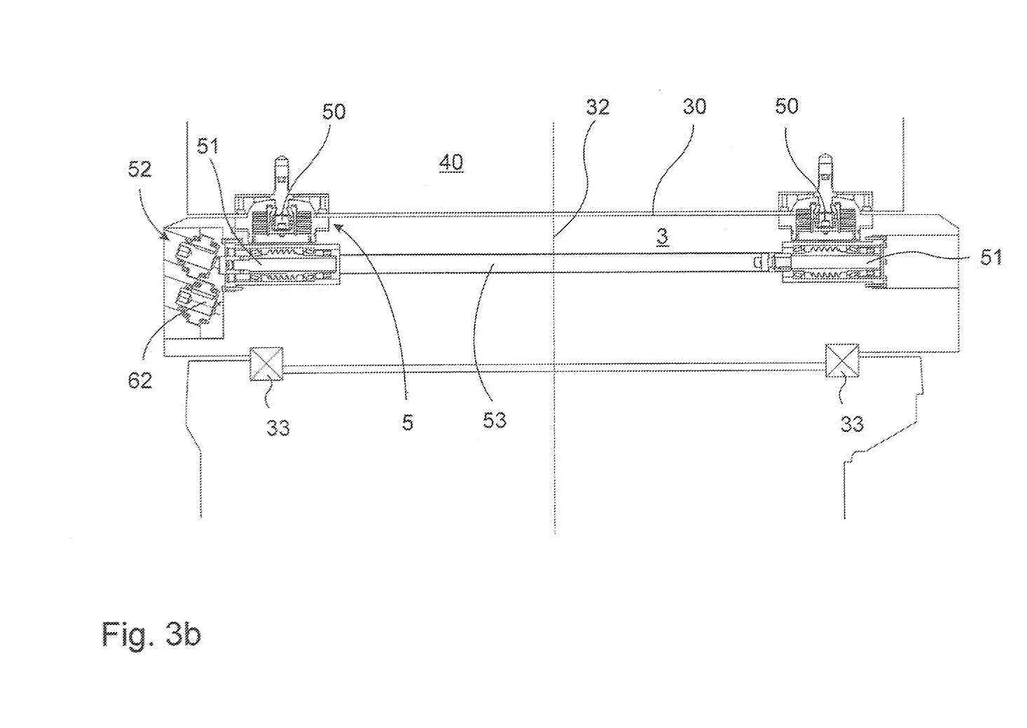

FIG. 3a is a lateral section view of a work piece table 3 of a machine tool according to a second example. It can be seen that both clamping means 50 of clamping device 5 are hydraulically actuated. To this end, in the work piece table 3 a hydraulic pump 56 is provided, which is fluidically connected with the clamping means 50 through hydraulic conduits 57. The hydraulic pump 56 may be actuated by the clamping power connection 52. This means, in particular, that a hexagon held in the clamping power connection 52 or a similar follower may rotate the clamping power connection 52, wherein the energy transmitted is used for operating the hydraulic pump 56, which pumps hydraulic fluid to the clamping means 50 or removes it from them, depending on the direction of rotation of the follower. This also allows an adjustable reduction of the force applied.

It is also noted that the work piece table 3 of machine tool 1 according to the second example also has a lifting power connection 62. This lifting power connection 62 is arranged directly under the clamping power connection 52. The function of the lifting power connection 62 is explained in the following.

It is also to be noted that the work piece table 3 is supported on bearings 33, which ensure the possibility of rotation required for rotating the work piece table 3 around the rotation axis 32. On the upper side, the work piece table 3 forms a work piece table surface 30, on which the pallet 40 rests.

FIG. 3b is a lateral section view of a work piece table 3 of a machine tool according to a third example. The clamping device 5 according to the third example is not provided, in contrast to the second example, with any hydraulic driving of the clamping means 50. However, a mechanical actuation by a rotation rod 53 as in the first example is provided. Also in this way a reliable actuation of the clamping means 50 in both directions and with adjustable reduction may be achieved.

Differently from the first example, the rotating table 3 of the third example is provided, in addition to the clamping power connection 52 with a lifting power connection 62, which is similarly disposed under the clamping power connection 52, as in the second example. Its function is explained in the following.

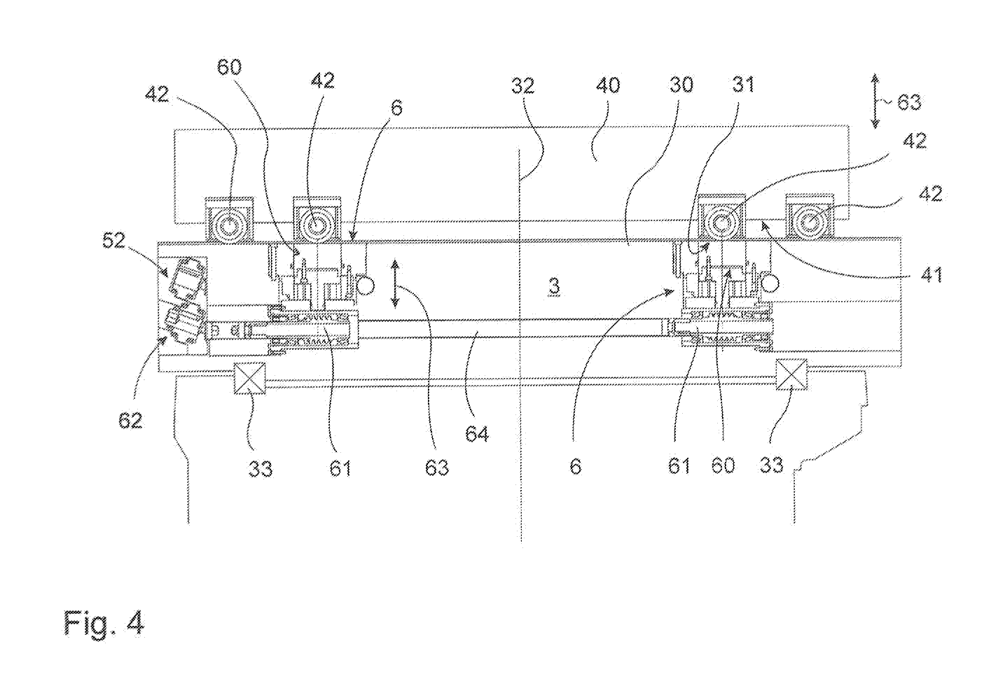

FIG. 4 is another lateral section view of the work piece table 3 in the third exemplary embodiment. It is to be noted that the work piece table 3 is provided with a lifting device 6. The lifting device 6 has two lifting means 60, which are distant from each other. To each lifting means 60 a lifting drive 61 is associated, which is used for driving the lifting means 60. In case of corresponding actuation, the respective lifting means 60 can move along a vertical direction 63 and therefore also exit the work piece table surface 30 of the work piece table 3. The obtained functionality is described hereafter.

For actuating the lifting drives 61, said lifting power connection 62 is used. This is connected to the lifting drives 61 by means of a further rotating rod 64. This allows a force transmission from a power transmission connection piece 20 to be introduced in the lifting power connection 62 to the lifting drives 61 and therefore the actuation of the lifting means 60 in both directions.

The pallet 40 is provided on its underside 41 with rollers 42, through which the pallet 40 may, among other things, move over the work piece table surface 30. The work piece table surface 30 therefore forms a track portion 31. Rollers 42 may also be used in particular for displace the pallet 40 from a preparation area not shown onto the work piece table surface 30.

When a respective roller 42 is above a lifting means 60, the respective lifting means 60 may be lifted by said actuation. The roller 42 is fixed, i.e. it cannot roll horizontally over the work piece table surface 30 anymore. If a plurality of rollers 42 are fixed in this way, also the pallet 40 is completely fixed. The lifting device 6 can therefore be advantageously used for fixing the pallet, so that the work piece held by the pallet 40 may be machined. This does not require the installation of additional driving mechanisms or delicate power transmission mechanisms, but can be performed by only using the motor spindle 2 with a corresponding tool.

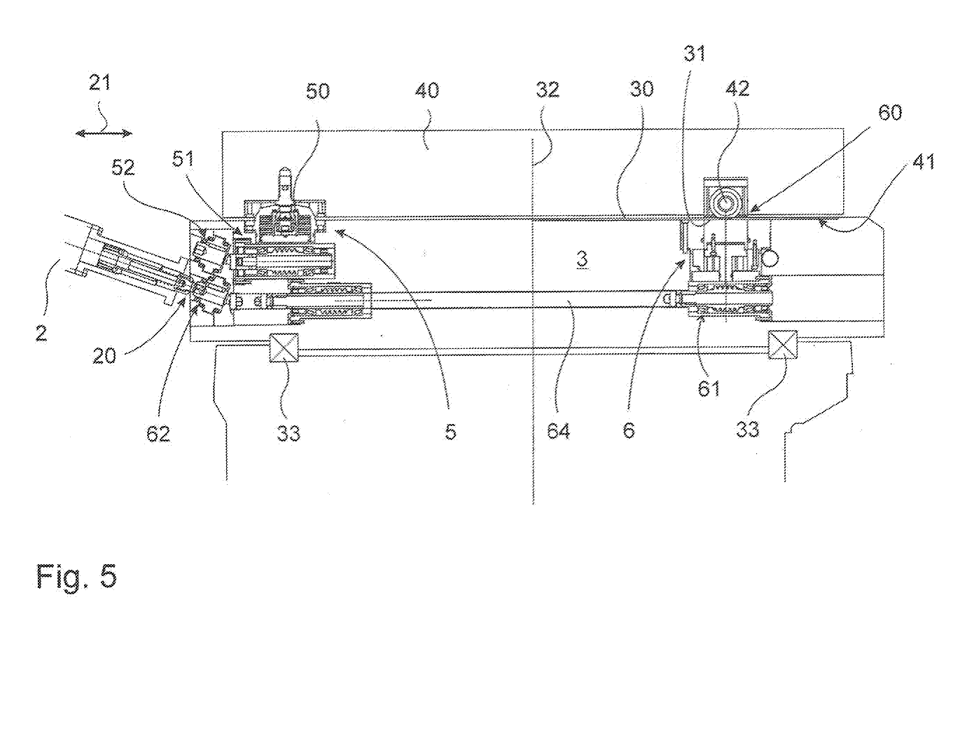

FIG. 5 is a lateral sectional view of a work piece table 3 according to a fourth example. Contrary to FIG. 4, only the drive of one lifting means 61 is shown. Moreover, a clamping means 50 with clamping drive 51 is shown near the clamping power connection 52.

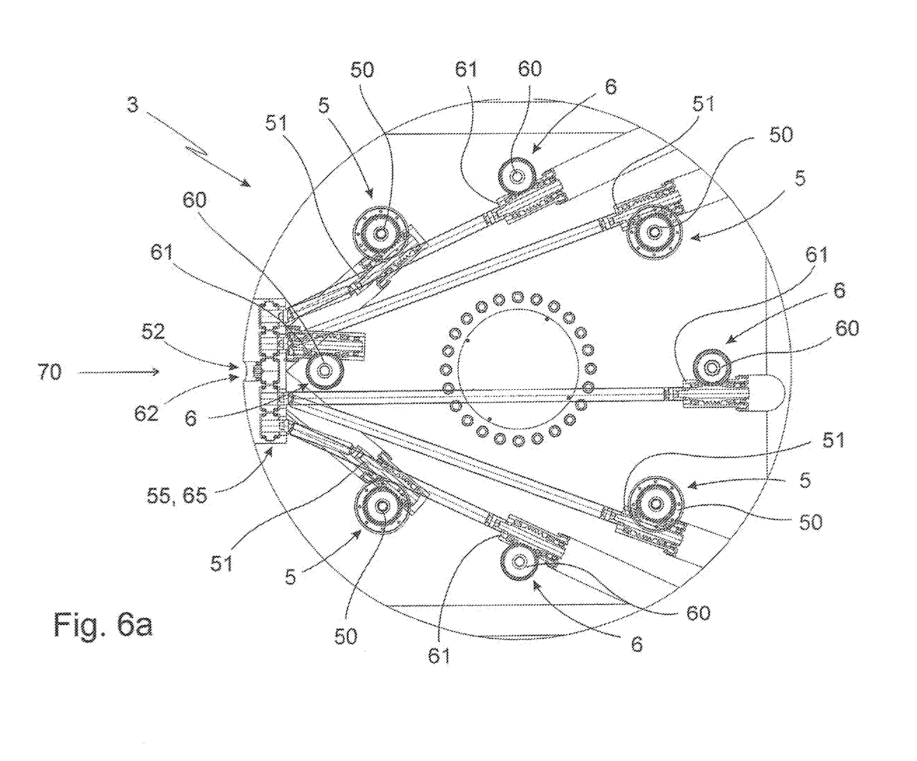

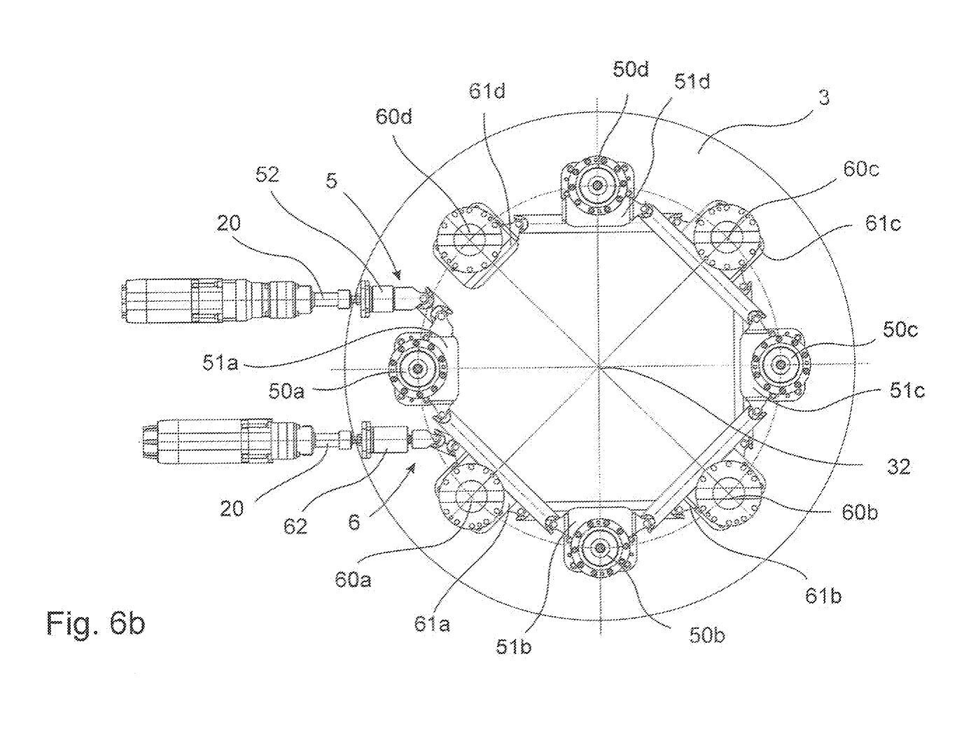

FIG. 6a is a sectional plan view of a work piece table 3 according to a fifth example. Both clamping means 50 and lifting means 60 with their already described components used for driving as well as their arrangement on the work piece table 3 are visible. It is also visible that in the work piece table 3 transmissions 55, 65 for driving the clamping device 5 and the lifting device 6 are provided. These are connected to a central power connection 70, which unifies the functions of the clamping power connection 52 and the lifting power connection 62. Transmissions 55, 65 are connectable in a switchable way with the central power connection 70, wherein, the mechanism used for switching is not shown. Two connections may therefore be omitted.

FIG. 6b is a sectional plan view of a work piece table 3 according to a sixth example, which, with respect to the fifth embodiments is modified in that it does not comprise a central power connection 70, but two separate connections 52, 62. By means of the clamping power connection 52, four clamping means 50a, 50b, 50c, 50d are operated with corresponding clamping drives 51a, 51b, 51c, 51d. The lifting power connection 62 allows the operation of four lifting means 60a, 60b, 60c, 60d by respective associated lifting drive 61a, 61b, 61c, 61d. This takes place as already described.

Claims provided with this application and claims provided in the future do not hold any prejudice regarding the provision of an extensive protection.

If, in this case, in performing a more thorough investigation, in particular also of the corresponding state of the art, it is ascertained that any one of the features may be advantageous for the object of the invention, but not of crucial importance for the achievement of such object, it is obvious that a formulation is already envisaged, which does not include such a feature, in particular in the main claim. Such a sub-combination is covered by the disclosure of the present application.

It is also to be noted that the different forms and variants of the invention, which have been described in the various embodiments and which are shown in the figures, may be arbitrarily combined with each other. Single or multiple features may in particular be arbitrarily swapped. These combinations of features are also disclosed.

The references provided in the dependent claims relate to the further development of the subject of the main claim through the features of the particular dependent claim. However, this should not be construed as a waiver of the right to independent, objective protection of the features of the dependent claims.

Features, which are only disclosed in the description or even single features from claims, which comprise a plurality of features, may be introduced, as of inventive importance, for delimiting the state of the art, in the independent claim/claims, also when such features have been cited together with other features, or when they attain particularly favorable results in connection with other features.

What is claimed is:

1. A machine tool with at least one motor spindle rotatably driving a respective tool and a work piece table, at or on which the at least one work piece is directly or indirectly clamped, through a pallet carrying the work piece during the machining process, by a clamping device and the clamping device comprises at least a clamping means, a clamping device and a clamping power connection (52), wherein the clamping means cooperates with the work piece or the pallet carrying the work piece, the clamping drive drives, using the power provided by the clamping power connection, the clamping means for clamping and/or releasing the work piece and the clamping power connection is temporarily connectable with a power transmission connection piece, wherein the power transmission connection piece is operatively connected to a power source and the power transmission connection piece is movable in a forward or backward direction with respect to the clamping power connection by a moving drive.

2. The machine tool, according to claim 1, wherein for transporting the work piece or the pallet carrying the work piece from a preparation area to the work piece table and back a rolling track is provided on the work piece table surface, on which the work piece or the pallet is resting for transport, or the pallet is provided with rollers on its underside and the rollers, in the clamping position of the work piece or the pallet are positioned on the work piece table on a respective track portion and in the work piece table a lifting device is provided, wherein the lifting device has at least one lifting means, one lifting drive and a lifting power connection, wherein the lifting means cooperates with the lifting means with the rolling track or the track portions, the lifting drive, by use of the power provided by the lifting power connection, drives the lifting means for lowering and/or lifting the rolling track or the track portion and the lifting power connection is temporarily connectable with a power transmission connection piece, wherein the power transmission connection piece is operatively connected to a power source and the power transmission connection piece is movable in a forward or backward direction with respect to the lifting power connection by means of a moving drive.

3. The machine tool according to claim 2, characterized in that the work piece table is arranged to be moved and positioned along a linear guide by a linear drive and/or the work piece table is arranged to be moved and positioned around a vertical axis of rotation or an axis of rotation perpendicular to the linear axis by a rotating drive, and/or in case of relative movement of approach of power transmission connection piece on one side and the clamping power or lifting power connection on the other, these are engaged to each other, in particular by form fit.

4. The machine tool according to claim 3, characterized in that on the work piece table a central power connection is provided, which is temporarily used as a clamping power connection and as a lifting power connection and a switching device for selectively connecting the clamping drive or the lifting drive to the power connection is provided, and/or as a power source the rotational energy of a screwdriver or motor spindle, electrical energy, pneumatic or hydraulic energy is used and that the power transmission connection piece is a torque transmitting element, such as a polygon, electrical connector or pneumatic or hydraulic coupling element and/or the clamping power connection or the lifting power connection are shaft stubs to be driven by the connectable rotation power source, electrical connector counter contact or as a hydraulic or pneumatic coupling counter element.

5. The machine tool according to claim 4, characterized in that the power transmission connection piece is fixed to the machining tool and that the work piece table and the connected clamping or lifting power connections are movable, connectable and releasable, according to a linear movement along a linear guide or in a rotational way around a rotational axis, to and from the power transmission connection piece, and/or the motor spindle is arranged to be movably positioned along two linear axes (Y,Z) by means of their respective motor spindle linear drive wherein both linear axis (Y,Z) of the motor spindles are perpendicular to the longitudinal extension of the linear guide (X) of the work piece table.

6. The machine tool according to claim 5, characterized in that a movement drive is formed by at least one motor spindle linear drive and/or as a clamping or lifting drive, a transmission, a hydraulic pump, an electric motor, a pressure supply or a pressure accumulator are provided and/or the clamping means is a spring loaded clamping gripper arrangement and the clamping drive provides a force opposed to the spring for opening the clamping means, and/or the lifting means is provided with a linear guide and lifts or lowers the rolling track or the track portion.

7. The machine tool according to claim 6, characterized in that on the work piece table in the area of the clamping or lifting power connection, a control line connection is provided which interacts with the clamping drive, lifting drive or the switching device and which is connectable to a control line connection piece and wherein the control line connection piece is connected with the machine control of the machine tool and the control line connection piece is arranged to be moved to and from the control line connection by a movement drive, and/or a respective at least two lifting or clamping means are connected by a partial power line, and/or the clamping means exerts a clamping force which is parallel, in particular radial with respect to the rotation axis or perpendicular to the work piece surface of the work piece table.

8. A machine tool with at least one motor spindle and a work piece table, on which the at least one work piece is clamped during the machining, by means of a clamping device and the clamping device comprises at least one clamping mean, a clamping drive and a shaft stub, wherein the clamping means cooperates with the work piece or with a pallet carrying the work piece, the clamping drive, using the energy provided by the shaft stub, drives the clamping means for clamping and/or releasing the work piece and the shaft stub is temporarily connectable to a screwdriver or the motor spindle, wherein the screwdriver or the motor spindle are movable to and from the shaft stub by a movement drive.

9. A machine tool with at least one motor spindle and a work piece table, on which the at least one work piece is clamped during the machining, by a clamping device, and in the work piece table a lifting device is provided, wherein the lifting device comprises at least one lifting means, one lifting drive and one shaft stub, wherein the lifting means cooperates with the rolling track, the lifting drive drives, using the energy provided by the shaft stub, the lifting means in order to lower and/or lift the rolling track and the shaft stub is temporarily connectable with a screwdriver or with the motor spindle, wherein the screwdriver or the motor spindle are movable towards the shaft stub or back by means of a movement drive.

10. A method for loading a work piece from a preparation area on or at the work piece table of a machine tool according claim 1, with a lifting device and a clamping device, wherein
the work piece is transported on a rolling track arranged in the work piece table, or the work piece is transported on a pallet carrying the work piece with rollers on the work piece table, and the rollers, at the end of the movement, are positioned on track portions, wherein at the same time or afterwards, a power transmission connection piece is moved with respect to the work piece table in a way that a connection between the power transmission connection piece and a lifting power connection is established, energy then goes to a lifting means of the lifting device and the rolling track or the track portions are lowered in a way that the rolling track or rollers are no more active and the work piece or the pallet carrying the work piece rests on the work piece table, wherein at the same time or afterwards, the power transmission connection piece is moved with respect to the work piece table or the switching device is operated in a way that a connection between the power transmission connection piece and a clamping power connection is established, so that energy may then be provided to a clamping means of the clamping device and clamping elements positioned on the work piece table or on the pallet carrying the work piece table cooperating with the clamping means engage the work piece and clamp it in an exact position on the work piece table and then the power transmission connection piece is separated from the clamping power connection, whereby the active connection between power transmission connection piece and clamping power connection is interrupted.

11. The method according to claim 10, characterized in that, after the work piece or the pallet carrying the work piece is resting on the work piece table, the work piece table is rotated and/or linearly moved and/or initially the power transmission connection piece is connected with lifting power connection, this connection is interrupted, the work piece table is rotated and/or linearly moved and then the power transmission connection piece is connected to the clamping power connection.
